(19) United States
(12) Patent Application Publication
(10) Pub. No.: US 2016/0291407 A1
(43) Pub. Date: Oct. 6, 2016

(54) BACKLIGHT MODULE AND DISPLAY DEVICE USING SAME

(71) Applicant: HON HAI PRECISION INDUSTRY CO., LTD., New Taipei (TW)

(72) Inventor: YU-CHI LI, New Taipei (TW)

(21) Appl. No.: 14/809,441

(22) Filed: Jul. 27, 2015

(30) Foreign Application Priority Data
Mar. 31, 2015 (TW) 104110579

(51) Int. Cl. G02F 1/1335

(52) U.S. Cl. CPC G02F 1/133605; G02F 1/133603

(57) ABSTRACT

A display device includes a a display module and backlight module for providing light required by the display module. The backlight module includes a light source assembly and a reflector. The reflector includes a bottom plate and a plurality of side plates coupled to the bottom plate. At least one of the plurality of side plates includes at least one reflectance adjustment member to adjust a light reflectance value (LRV) of the at least one of the side plates.

### CROSS-REFERENCE TO RELATED APPLICATIONS

This application claims all benefits accruing under 35 U.S.C. §119 from Taiwanese Patent Application No. 104,110,579, the content of which is hereby incorporated by reference.

### FIELD

The subject matter herein generally relates to direct-type backlight module includes a reflective film and a display device using the same, the display device is typically a liquid crystal display device.

### BACKGROUND

A backlight module of a display device usually employs a light emitting unit, a light reflective film and a plurality of optical films for providing light sources for the display device. For a straight down type backlight module, the light reflective film includes a bottom portion and at least one side reflective portion located at the side of a light emitting unit.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a cross-sectional view of a display device according to a first exemplary embodiment of the present disclosure.

FIG. 2 is an isometric view of a reflector and a light source assembly located within a base plate of FIG. 1.

FIG. 3 is a cross-sectional view of a display device according to a second exemplary embodiment of the present application.

FIG. 4 is an isometric view of a reflector and a light source assembly located within a base plate of FIG. 3.

FIG. 5 is an enlarged view of a circled region VI of FIG. 4.

FIG. 6 illustrates a cross-sectional view of a display device according to a third exemplary embodiment of the present disclosure.

FIG. 7 is an isometric view of a reflector and a light source assembly located within a base plate of FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “comprising”, when utilized, means “including, but not necessarily limited to”; it specifically indicates open-ended inclusion or membership in the so-described combination, group, series and the like.

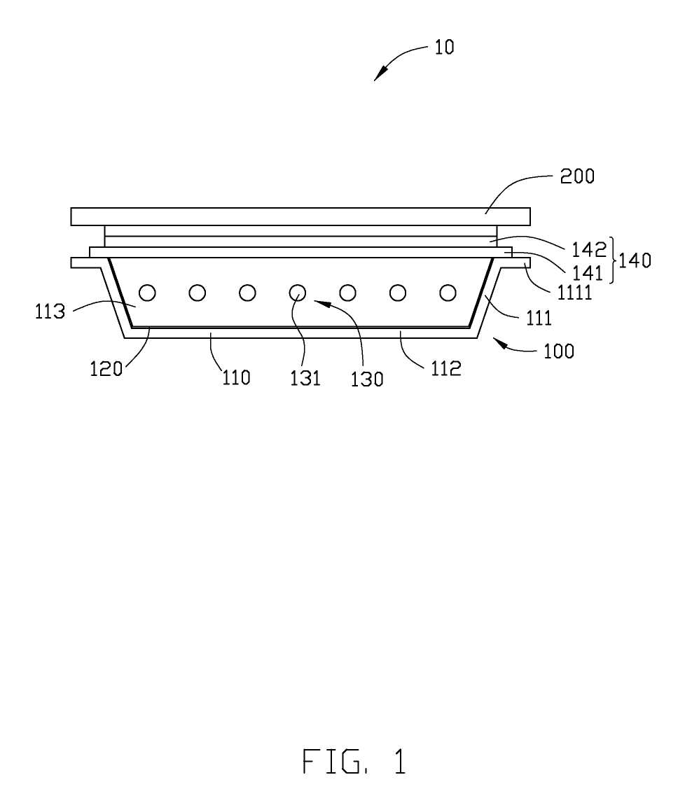

FIG. 1 illustrates a cross-sectional view of a display device 10 according to a first exemplary embodiment. In at least one embodiment, the display device 10 can be a liquid crystal display (LCD) device. The display device 10 can include a backlight module 100 and a display module 200. The backlight module 100 provides light sources required by the display module 200.

The backlight module 100 includes a base plate 110, a reflector 120, a light source assembly 130, and an optical assembly 140. The reflector 120, the light source assembly 130, and the optical assembly 140 are respectively located on the base plate 110 in that order. Light emitted from the light source assembly 130 is converted into plane light by the optical assembly 140. The plane light is emitted to the display module 200 from the optical assembly 140. The reflector 120 reflects a portion of the light emitted to the optical assembly 140, to increase the light emitted to the display module 200. The base plate 110 can be made of metal materials or plastics. The light source assembly 130 can be a light emitting diode (LED) bar comprising a plurlality of light sources 131. For example, the light sources 131 can be LEDs.

In at least one embodiment, the base plate 110 includes a bottom wall 112 and a plurality of sidewalls 111 coupled end to end and extending from the base plate 110. In the illustrated embodiment, the base plate 110 includes four sidewalls 111. Further, the base plate 110 can include a plurality of holding members 1111 extending from sidewalls 111 for holding the optical assembly 140. The base plate 110 and the optical assembly 140 located on the base plate 110 form an enclosed space 113 to receive the reflector 120 and the light source assembly 130 therein. The optical assembly 140 can include a diffusion film 141 and an optical film group 142 consisting of at least two brightness enhancement films (BEF).

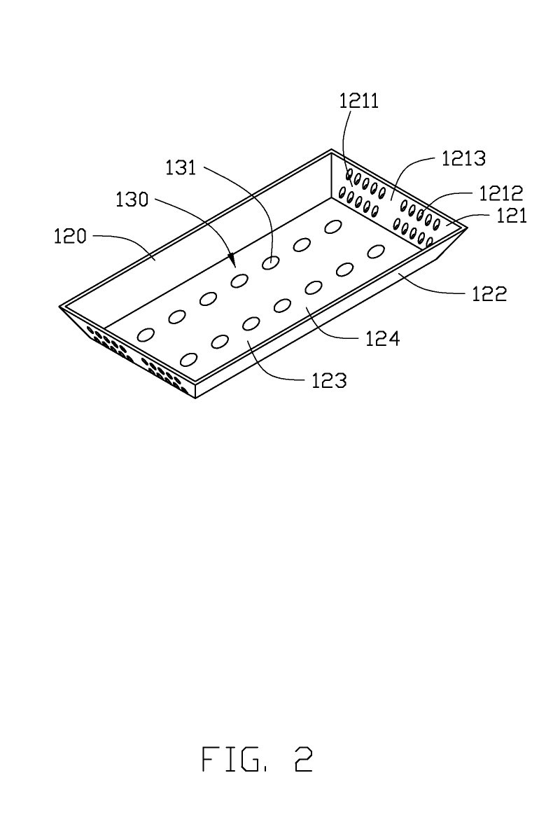

FIG. 2 illustrates a diagrammatic view of the reflector 120 and the light source assembly 130 located within the base plate 110. The reflector 120 can include a plurality of side plates and a bottom plate 123 coupled to the side plates. The plurality of side plates extend from the bottom plate 123 to corporately form an optical cavity 124. In at least one embodiment, the plurality of side plates can include two opposite first side plates 121 and two opposite second side plates 122 respectively corresponding to the four sidewalls 111 of the base plate 110. A shape or configuration of the reflector 120 is the same or similar to that of the base plate 110, thereby closely engaging the reflector 120 to the base plate 110.

Light emitted from the light source assembly 130 is introduced to the plurality of side plates of the reflector 120. In at least one embodiment, at least one of the plurality of side plates (such as the first side plate 121) includes a first region 1211 corresponding to the light source assembly 130 and a second region 1213 beside the first region 1211. In the illustrated embodiment, incident light emitted from the light source assembly 130 received by the first region 1211 is more than the incident light received by the second region 1213. Therefore, the light reflected from the first region 1211 may be more than the light reflected from the second region 1213. In at least one embodiment, the light source assembly 130 includes a plurality of light sources 131 arranged in two parallel rows within the optical cavity 124. Thus, the first region 1211 of the at least one of the plurality of side plates is corresponding to (such as “aligned with”) the two parallel rows in which the light sources 131 are arranged.

In at least one embodiment, the first region 1211 includes at least one reflectance adjustment member to adjust (such as “decrease”) a light reflectance value (LRV) of the at least one of the side plates. For example, the at least one reflectance adjustment member can include a plurality of holes 1212 which can decrease a light reflectance of the first region 1211, thereby improving a brightness uniformity of the display device 10. The plurality of holes 1212 can pass through the first region 1211 of the at least one of the side plates to expose a portion of the base plate 110.

In other embodiments, each of the plurality of side plates of the reflector 120 can include the first portion 1211 which include the at least one reflectance adjustment member and the second portion 1213 which does not have the at least one microstructured member, to greatly improving the brightness uniformity of the display device 10.

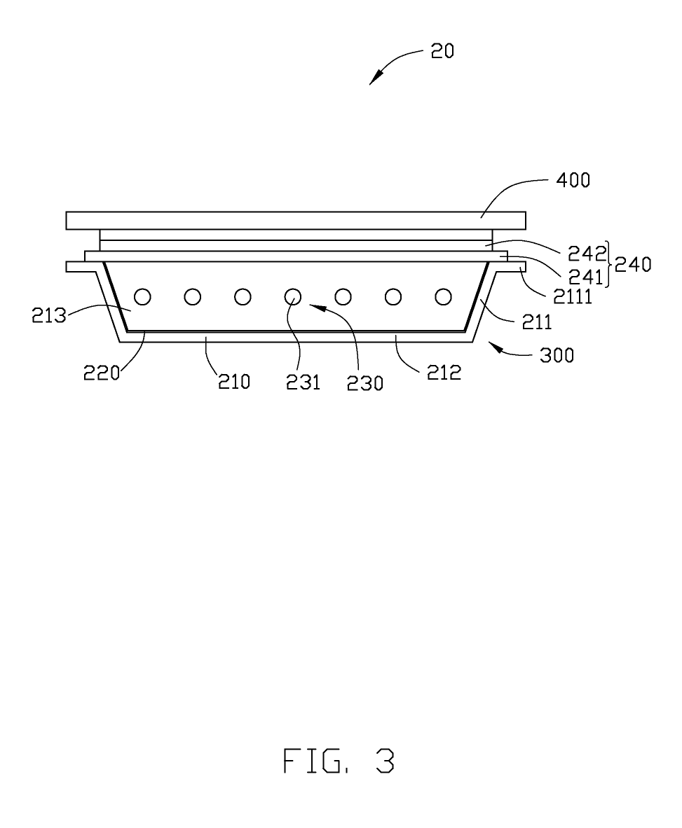

FIG. 3 illustrates a cross-sectional view of a display device 20 according to a second exemplary embodiment. In at least one embodiment, the display device 10 can be a liquid crystal display (LCD) device. The display device 20 can include a backlight module 300 and a display module 400. The backlight module 300 provides light sources required by the display module 400.

The backlight module 300 includes a base plate 210, a reflector 220, a light source assembly 230, and an optical assembly 240. The reflector 220, the light source assembly 230, and the optical assembly 240 are respectively located on the base plate 210 in that order. Light emitted from the light source assembly 230 is converted into plane light by the optical assembly 240. The plane light is then introduced to the display module 400 from the optical assembly 240. The reflector 220 reflects a portion of the light emitted to the optical assembly 240, to increase the light introduced to the display module 400. The base plate 210 can be made of metal materials or plastics. The light source assembly 230 can be a light emitting diode (LED) bar comprising a plurlality of light sources 231. For example, the light sources 231 can be LEDs.

In at least one embodiment, the base plate 210 includes a bottom wall 212 and a plurality of sidewalls 211 coupled end to end and extending from the base plate 210. In the illustrated embodiment, the base plate 210 includes four sidewalls 211. Further, the base plate 210 can include a plurality of holding members 2111 extending from sidewalls 211 for holding the optical assembly 240. The base plate 210 and the optical assembly 240 located on the base plate 210 corporately form an enclosed space 213 to receive the reflector 220 and the light source assembly 230 therein. The optical assembly 240 can include a diffusion film 241 and an optical film group 242 consisting of at least two brightness enhancement films (BEF).

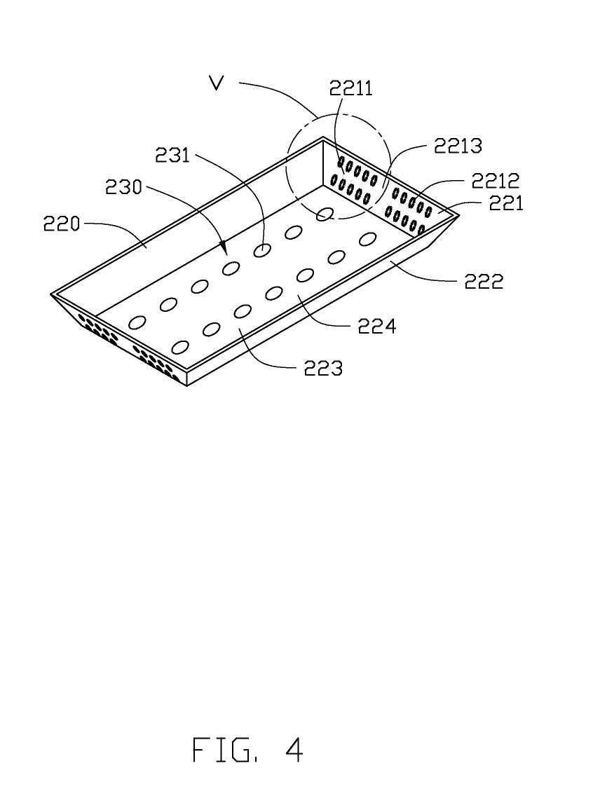

FIG. 4 illustrates a diagrammatic view of the reflector 220 and the light source assembly 230 located within a space formed by the sidewalls 211 and the bottom wall 212 of the base plate 210. The reflector 220 can include a bottom plate 223 and a plurality of side plates coupled to the bottom plate. The plurality of side plates extend from the bottom plate 223 to corporately form an optical cavity 224. In at least one embodiment, the plurality of side plates can include two opposite first side plates 221 and two opposite second side plates 222 respectively corresponding to the four sidewalls 211 of the base plate 210. A shape or configuration of the reflector 220 is the same or similar to that of the base plate 210, thereby closely engaging the reflector 220 to the base plate 210.

Light emitted from the light source assembly 230 can be introduced to the plurality of side plates of the reflector 220. In at least one embodiment, at least one of the plurality of side plates (such as the first side plate 221) includes a first region 2211 corresponding to the the light sources 231 of the light source assembly 230 and a second region 2213 beside the first region 2211. In the illustrated embodiment, incident light from the light source assembly 230 received by the first region 2211 is more than the incident light received by the second region 2213. Therefore, the light reflected from the first region 2211 is more than that of the second region 2213. In at least one embodiment, the plurality of light sources 231 of the light source assembly 230 are arranged in two parallel rows within the optical cavity 224. Thus, the first region 2211 of the at least one of the plurality of side plates is corresponding to (such as aligned with) the two parallel rows in which the light sources 231 are arranged.

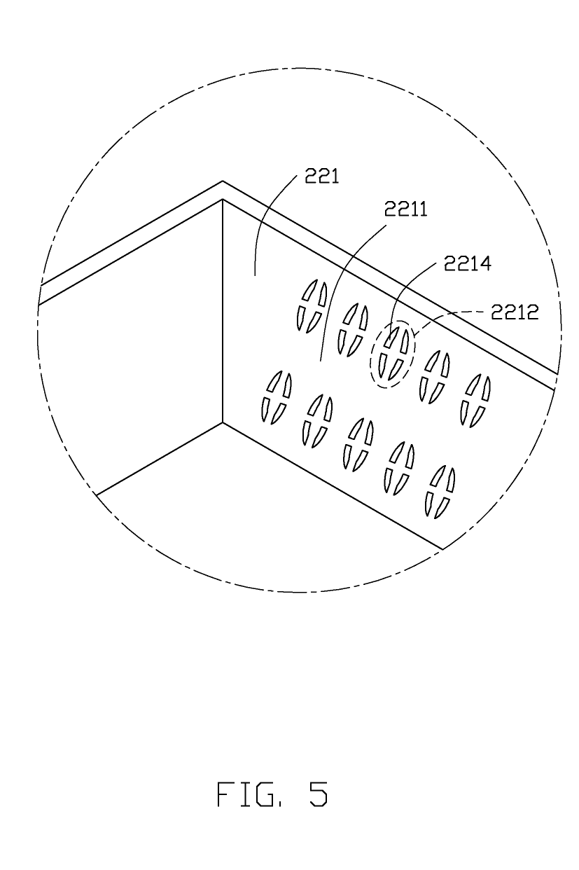

FIG. 5 illustrates an enlarged view of a circled region VI of FIG. 4. In at least one embodiment, the first region 2211 includes at least one reflectance adjustment member to adjust (such as “decrease”) a light reflectance value (LRV) of the at least one of the side plates. For example, the at least one reflectance adjustment member can include a plurality of microporous patterns 2212 capable of decreasing a light reflectance of the first region 2211, thereby improving a brightness uniformity of the display device 20. In the illustrated embodiment, each of the microporous patterns 2212 can include a plurality of openings 2214 passing through the first region 2211 of the at least one of the plurality of side plates. The plurality of openings 2214 of each microporous pattern 2212 are arranged at intervals to form an ellipse likeness shape. In other embodiments, the plurality of openings 2214 can corporately form other predetermined shape, such as triangle likeness shape, circle likeness shape, rectangle likeness shape, or rhombus likeness shape.

In other embodiments, each of the plurality of side plates of the reflector 220 can include the first portion 2211 which include the at least one reflectance adjustment member and the second portion 2213 which does not have the at least one microstructured member, to greatly improving the brightness uniformity of the display device 20.

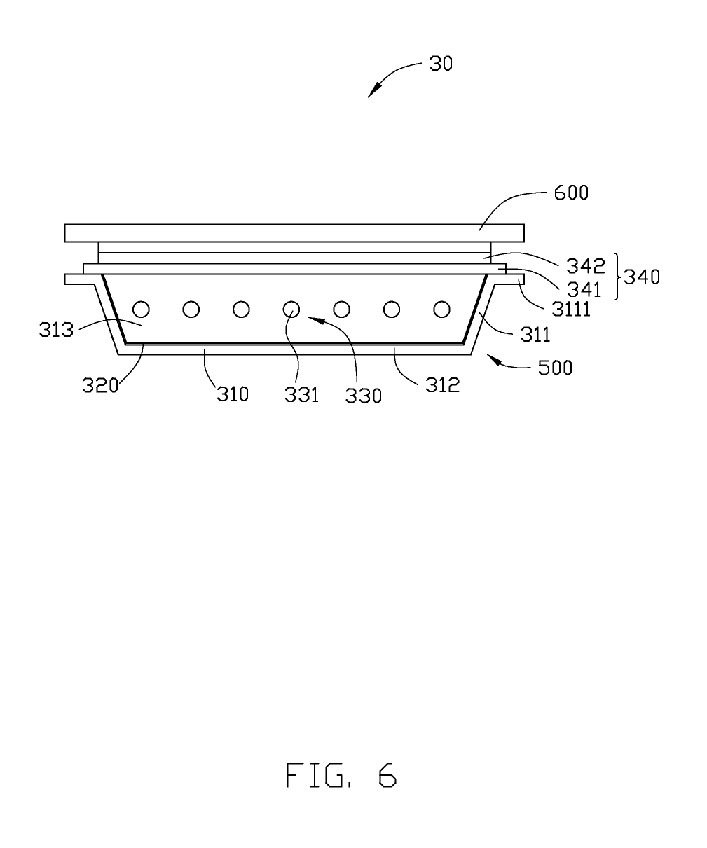

FIG. 6 illustrates a cross-sectional view of a display device 30 according to a third exemplary embodiment. In at least one embodiment, the display device 30 can be a liquid crystal display (LCD) device. The display device 30 can include a backlight module 500 and a display module 600. The backlight module 500 provides light sources required by the display module 600.

The backlight module 500 includes a base plate 310, a reflector 320, a light source assembly 330, and an optical assembly 340. The reflector 320, the light source assembly 330, and the optical assembly 340 are respectively located on the base plate 310 in that order. Light emitted from the light source assembly 330 is converted into plane light by the optical assembly 340. The plane light is then introduced to the display module 600 from the optical assembly 340. The reflector 320 reflects a portion of the light emitted to the optical assembly 340, to increase the light introduced to the display module 600. The base plate 310 can be made of metal materials or plastics. The light source assembly 330 can be a light emitting diode (LED) bar comprising a plurlality of light sources 331. For example, the light sources 331 can be LEDs.

In at least one embodiment, the base plate 310 includes a bottom wall 312 and a plurality of sidewalls 311 coupled end to end and extending from the base plate 310. In the illustrated embodiment, the base plate 310 includes four sidewalls 311. Further, the base plate 310 can include a plurality of holding members 3111 extending from sidewalls 311 for holding the optical assembly 340. The base plate 310 and the optical assembly 340 located on the base plate 310 corporately form an enclosed space 313 to receive the reflector 320 and the light source assembly 330 therein. The optical assembly 340 can include a diffusion film 341 and an optical film group 342 consisting of at least two brightness enhancement films (BEF).

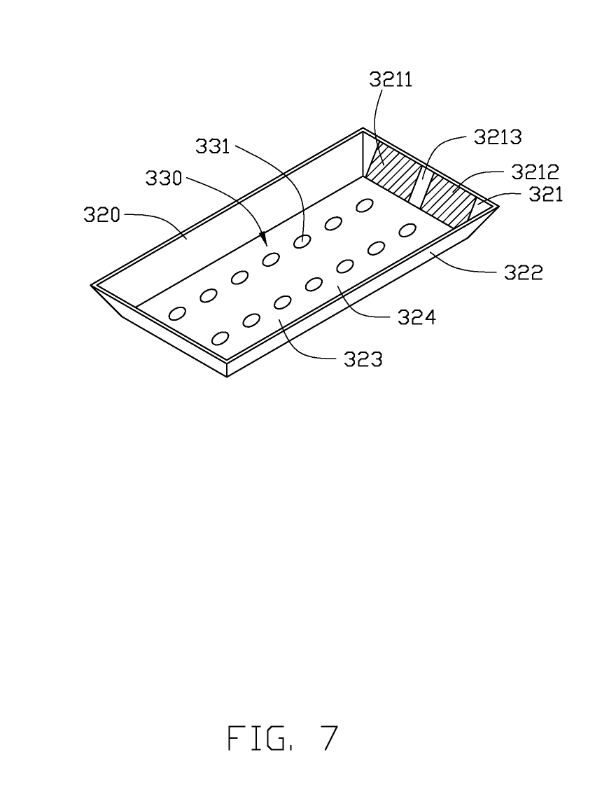

FIG. 7 illustrates a diagrammatic view of the reflector 320 and the light source assembly 330 located within a space formed by the sidewalls 311 and the bottom wall 312 of the base plate 310. The reflector 320 can include a plurality of side plates and a bottom plate 323 coupled to the side plates. The plurality of side plates extend from the bottom plate 323 to corporately form an optical cavity 324. In at least one embodiment, the plurality of side plates can include two opposite first side plates 321 and two opposite second side plates 322 respectively corresponding to the four sidewalls 311 of the base plate 310. A shape or configuration of the reflector 320 can be the same or similar to that of the base plate 310, thereby closely engaging the reflector 320 to the base plate 310.

Light emitted from the light source assembly 330 can be introduced to the plurality of side plates of the reflector 320. In at least one embodiment, at least one of the plurality of side plates (such as the first side plate 321) includes a first region 3211 corresponding to the the light sources 331 of the light source assembly 330 and a second region 3213 beside the first region. In the illustrated embodiment, incident light from the light source assembly 330 received by the first region 3211 is more than the incident light received by the second region 3213. Therefore, the light reflected from the first region 3211 is more than that of the second region 3213. In at least one embodiment, the plurality of light sources 331 of the light source assembly 330 are arranged in two parallel rows within the optical cavity 324. Thus, the first region 3211 of the at least one of the plurality of side plates is corresponding to the two parallel rows in which the light sources 331 are arranged.

The first region 3211 can include at least one reflectance adjustment member to adjust (such as “decrease”) a light reflectance value (LRV) of the at least one of the side plates. For example, the at least one reflectance adjustment member can include at least one grey tone portion 3212 capable of decreasing a light reflectance of the first region 3211, thereby improving a brightness uniformity of the display device 30. In the illustrated embodiment, the at least one grey tone portion 3212 can be formed on the first region 3211 by coating grey tone materials on a corresponding surface of the first region 3211. In other embodiment, the at least one grey tone portion 3212 can be adhesive materials (such as adhesive tapes) adhered to the first region 3211.

In other embodiments, each of the plurality of side plates of the reflector 320 can include the first portion 3211 which include the at least one reflectance adjustment member and the second portion 3213 which does not have the at least one microstructured member, to greatly improving the brightness uniformity of the display device 30.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in the matters of shape, size and arrangement of parts within the principles of the present disclosure to the full extent indicated by the broad general meaning of the terms in which the appended claims are expressed.

What is claimed is:

1. A backlight module comprising:
a light source assembly, and
a reflector coupled to the light source assembly and comprising a bottom plate and a plurality of side plates coupled to the bottom plate,
wherein at least one of the plurality of side plates comprises at least one reflectance adjustment member to adjust a light reflectance value (LRV) of the at least one of the side plates.

2. The backlight module as claimed in claim 1, wherein the at least one of the plurality of side plates comprises a first region corresponding to the light source assembly and a second region beside the first region, and the at least one reflectance adjustment member is located in the first region.

3. The backlight module as claimed in claim 2, wherein incident light from the light source assembly received by the first region is more than incident light received by the second region, and light reflected from the first region is more than light reflected from the second region.

4. The backlight module as claimed in claim 2, wherein the at least one reflectance adjustment member comprises at least one hole passing through the first region.

5. The backlight module as claimed in claim 2, wherein the at least one reflectance adjustment member comprises at least one microporous pattern having a predetermined shape.

6. The backlight module as claimed in claim 5, wherein each of the at least one microporous pattern comprises a plurality of openings passing through the first region, and the plurality of openings are arranged at intervals.

7. The backlight module as claimed in claim 6, wherein the plurality of openings corporately form the predetermined shape.

8. The backlight module as claimed in claim 2, wherein the at least one reflectance adjustment member comprises at least one grey tone portion.

9. The backlight module as claimed in claim 8, wherein the at least one grey tone portion is formed on the first region by coating grey tone materials on a corresponding surface of the first region.

10. The backlight module as claimed in claim 8, wherein the at least one grey tone portion is made of adhesive materials adhered to the first region.

11. A display device comprising:
a display module and a backlight module configured to provide light sources required by the display module, the backlight module comprising:
a light source assembly, and
a reflector coupled to the light source assembly comprising a bottom plate and a plurality of side plates coupled to the bottom plate,
wherein at least one of the plurality of side plates comprises at least one reflectance adjustment member to adjust a light reflectance value (LRV) of the at least one of the side plates.

12. The display device as claimed in claim 11, wherein the at least one of the plurality of side plates comprises a first region corresponding to the light source assembly and a second region beside the first region, and the at least one reflectance adjustment member is located in the first region.

13. The display device as claimed in claim 12, wherein incident light from the light source assembly received by the first region is more than incident light received by the second region, and light reflected from the first region is more than light reflected from the second region.

14. The display device as claimed in claim 12, wherein the at least one reflectance adjustment member comprises at least one hole passing through the first region.

15. The display device as claimed in claim 12, wherein the at least one reflectance adjustment member comprises at least one microporous pattern having a predetermined shape.

16. The display device as claimed in claim 15, wherein each of the at least one microporous pattern comprises a plurality of openings passing through the first region, and the plurality of openings are arranged at intervals.

17. The display device as claimed in claim 16, wherein the plurality of openings corporately form the predetermined shape.

18. The display device as claimed in claim 12, wherein the at least one reflectance adjustment member comprises at least one grey tone portion.

19. The display device as claimed in claim 18, wherein the at least one grey tone portion is formed on the first region by coating grey tone materials on a corresponding surface of the first region.

20. The display device as claimed in claim 18, wherein the at least one grey tone portion is made of adhesive materials adhered to the first region.
